(19) United States
(12) Patent Application Publication
(10) Pub. No.: US 2009/0195086 A1
(43) Pub. Date: Aug. 6, 2009

(54) Modular Mover for a Linear Motor

(76) Inventors: Lieh-Feng HUANG, Taichung (TW); Chia-Ming Chang, Taichung (TW)

Correspondence Address: Dr. BANGER SHIA, 102 Lindencrest Ct., Sugar Land, TX, 77479-5201, US

(21) Appl. No.: 12/025,024

(22) Filed: Feb. 2, 2008

(51) Int. Cl. H02K 41/03; H01F 27/24; H02K 41/02

(52) U.S. Cl. 310/12.15; 336/83; 336/212

(57) ABSTRACT

A modular mover for a linear motor comprises: a plurality of iron cores including internal coils and a connecting member. These iron cores have the same size and juxtaposed in the same direction on the connecting member. By supplying the coils with a current, each iron core can cooperate with a stator by generating magnetism. Since these iron cores have the same size, it just needs to produce a single sized iron cores. The mover output capability can be changed by changing a number of the iron cores so as to save the cost in producing different sized iron cores.

### BACKGROUND OF THE INVENTION

1. Field of the Invention

The present invention relates to a linear motor propulsion system, and more particularly to a modular mover for a linear motor.

2. Description of the Prior Art

The technology of a linear motor is that poles N and poles S are arranged in a straight line to form a stator, and a current direction of a coil in a mover can be changed to control the direction of magnetism of the mover so as to drive the mover to move linearly on the stator. The user only needs to set an equipment on the mover, so that the mover can carry it to perform linear motion.

However, different customers need different mover output capabilities, and the output capability of the mover is in direct proportion to the total size of the iron core. Referring to FIGS. 1-3, the length of the iron core Al shown in FIG. 1 is two thirds that of the iron core A2 shown in FIG. 2, so the output capability of the iron core A1 is two thirds that of the iron core A2. The iron core A3 shown in FIG. 3 is twice the length of the iron core Al shown in FIG. 1, so output capability of the iron core Al is one half that of the iron core A3. The manufacturer must produce the iron cores in different sizes according to different output capability requirements of the customer, accordingly different sized modules must be produced to manufacture the different sized iron cores, and this is a burden to the manufacturer. If the size of the iron core required by the customer has never been produced before, the manufacturer has to make a new mould or give up the business.

The present invention has arisen to mitigate and/or obviate the afore-described disadvantages.

### SUMMARY OF THE INVENTION

The primary objective of the present invention is to provide a modular mover for a linear motor, and each internal iron core will have the same size through modularization. By changing a number of the iron cores, an output capability of the mover can be changed by a single sized iron core.

To achieve the abovementioned objective, the mover are provided with a plurality of iron cores which include internal coils and a connecting member, and the iron cores have the same size and juxtaposed in the same direction on the connecting member.

By supplying the coils of the mover with a current, each iron core can generate magnetism. When the mover cooperates with a stator which includes a plurality of poles N and poles S arranged in an alternative manner, by changing the current direction of the coils of the mover, the direction of the magnetism of the mover can be changed to drive the mover to move linearly on the stator. In order to change the output capability of the movement of the mover, a number of the internal iron cores needs to be changed to change the total size of the internal iron cores of the mover. Since these iron cores have the same size, it only needs to produce a single sized module, and the cost will be saved greatly in the module processing.

### BRIEF DESCRIPTION OF THE DRAWINGS

FIG. 1 is an illustrative view of a first conventional mover;

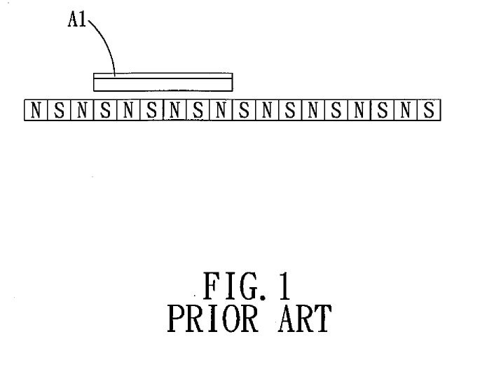

FIG. 2 is an illustrative view of a second conventional mover;

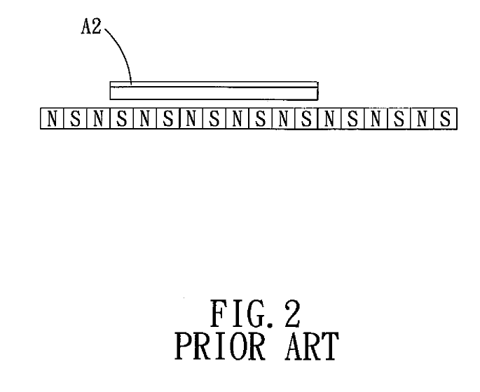

FIG. 3 is an illustrative view of a third conventional mover;

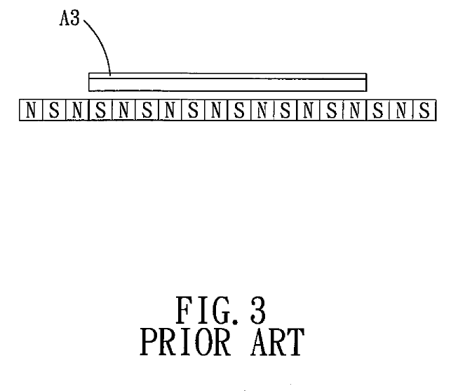

FIG. 4 is an illustrative view showing a modular mover with two iron cores in accordance with the present invention;

FIG. 5 is an illustrative view showing a modular mover with three iron cores in accordance with the present invention; and

FIG. 6 is an illustrative view showing a modular mover with four iron cores in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

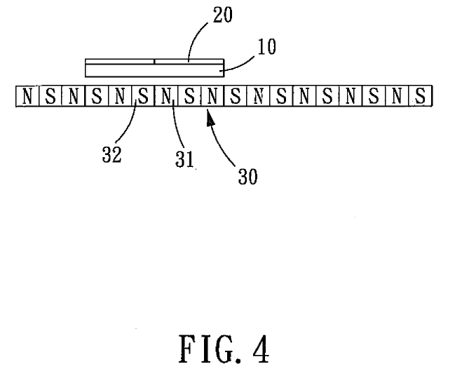

An embodiment of a modular mover for a linear motor in accordance with the present invention is shown in FIG. 4 and comprises: a connecting member 10 and two iron cores 20. The iron cores 20 have the same size and are provided with internal coils, and such two iron cores 20 are juxtaposed in the same direction on the connecting member.

When the mover is in use, firstly, the coils of each iron core 20 are supplied with a current to generate magnetism, and the mover cooperates with a stator 30 which includes a plurality of poles N 31 and poles S 32 arranged in an alternative manner. Changing the current direction of the iron cores 20 of the mover can change the direction of the magnetism of the iron cores 20, so that the mover can move linearly on the stator 30 in the direction in which these poles N 31 and poles S 32 are arranged.

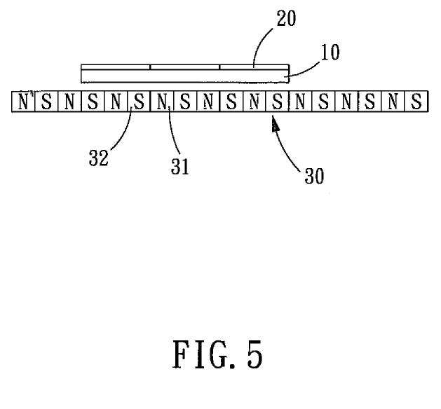

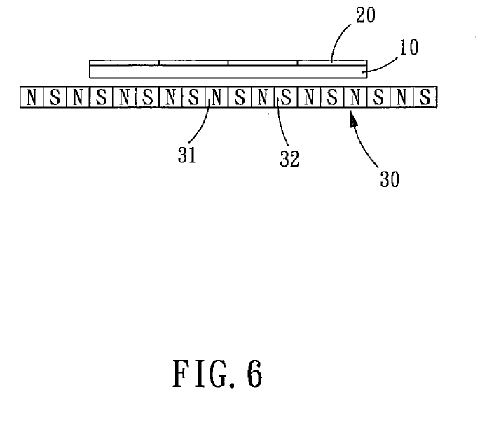

In order to meet different customers' requirements by changing the mover output capability, since the mover output capability is in direct proportion to the total size of the iron cores 20, a number of the iron cores 20 disposed on the connecting member 10 can be changed so that the mover output capability can be changed to meet the customers' requirements. The mover shown in FIG. 5 includes three iron cores 20 and the mover shown in FIG. 6 includes four iron cores 30. As compared with the mover using two iron cores 20 shown in FIG. 4, the output capability of the mover shown in FIG. 5 is 1.5 times that of the mover shown in FIG. 4, and the output capability of the mover shown in FIG. 6 is twice that of the mover shown in FIG. 4.As is known, by changing the number of the iron cores 20 used in the mover, the mover output capability can be changed. Thus through modularization of the iron cores, it only needs to produce a single sized module, the cost will be saved greatly in the module processing.

While we have shown and described various embodiments in accordance with the present invention, it is clear to those skilled in the art that further embodiments may be made without departing from the scope of the present invention.

What is claimed is:

1. A modular mover for a linear motor comprising:
a connecting member; and
a plurality of iron cores having the same size and being provided with internal coils and juxtaposed in the same direction on the connecting member.

2. The modular mover as claimed in claim 1, wherein the mover cooperates with a stator which includes a plurality of poles N and poles S arranged in an alternative manner.

3. The modular mover as claimed in claim 1, wherein a number of the iron cores is two.

4. The modular mover as claimed in claim 1, wherein a number of the iron cores is three.

5. The modular mover as claimed in claim 1, wherein a number of the iron cores is four.
